(19) United States
(12) Patent Application Publication
(10) Pub. No.: US 2024/0362889 A1
(43) Pub. Date: Oct. 31, 2024

(54) APPLYING DEPTH ESTIMATION TO KEYPOINT DETECTION AND DESCRIPTOR GENERATION FOR AUTONOMOUS DRIVING CONTROL

(71) Applicant: QUALCOMM Incorporated, San Diego, CA (US)

(72) Inventors: Amin Ansari, Federal Way, WA (US); Mandar Narsinh Kulkarni, Bridgewater, NJ (US); Ahmed Kamel Sadek, San Diego, CA (US)

(21) Appl. No.: 18/309,464

(22) Filed: Apr. 28, 2023

(51) Int. Cl. G06V 10/46; G06T 7/246; G06T 7/50; G06T 7/70; G06V 20/58

(52) U.S. Cl. CPC G06V 10/46; G06T 7/248; G06T 7/50; G06T 7/70; G06V 20/58

(57) ABSTRACT

An example device for processing image data includes a memory configured to store image data; and one or more processors implemented in circuitry and configured to: determine a set of keypoints representing objects in an image of the image data captured by a camera of a vehicle; determine depth values for the objects in the image; determine positions of the objects relative to the vehicle using the set of keypoints and the depth values; and at least partially control operation of the vehicle according to the positions of the objects. For example, the depth values may represent descriptors for the keypoints or be used to determine the descriptors for the keypoints.

### TECHNICAL FIELD

This disclosure relates to artificial intelligence, particularly as applied to autonomous driving systems.

### BACKGROUND

Techniques are being researched and developed related to autonomous driving and advanced driving assistance systems. For example, artificial intelligence and machine learning (AI/ML) systems are being developed and trained to determine how best to operate a vehicle according to applicable traffic laws, safety guidelines, external objects, roads, and the like. Using cameras to collect images, depth estimation is performed to determine depths of objects in the images. Depth estimation can be performed by leveraging various principles, such as calibrated stereo imaging systems and multi-view imaging systems.

Various techniques have been used to perform depth estimation. For example, test-time refinement techniques include applying an entire training pipeline to test frames to update network parameters, which necessitates costly multiple forward and backward passes. Temporal convolutional neural networks rely on stacking of input frames in the channel dimension and bank on the ability of convolutional neural networks to effectively process input channels. Recurrent neural networks may process multiple frames during training, which is computationally demanding due to the need to extract features from multiple frames in a sequence and does not reason about geometry during inference. Techniques using an end-to-end cost volume to aggregate information during training are more efficient than test-time refinement and recurrent approaches, but are still non-trivial and difficult to map to hardware implementations.

### SUMMARY

In general, this disclosure describes techniques for processing image data to determine depths of objects in the image data relative to a position of a vehicle including a camera that captured the image data. An autonomous driving unit of the vehicle may use the depths of the objects along with keypoints extracted from the image data to make various determinations. For example, the autonomous driving unit may determine whether the keypoints correspond to stationary objects, such as landmarks (e.g., bridges, mountains, buildings, signs, or the like) or to mobile objects, such as other vehicles clouds, animals, or the like. Then, when determining, for example, a location of the vehicle, the mobile objects may be removed from consideration, and only the stationary objects may be considered. Likewise, depth values for the stationary objects, relative to the vehicle, may be used to triangulate the position of the vehicle relative to the stationary objects.

In one example, a method of processing image data includes determining, by one or more processors implemented in circuitry, a set of keypoints representing objects in an image captured by a camera of a vehicle; determining, by the one or more processors, depth values for the objects in the image; determining, by the one or more processors, positions of the objects relative to the vehicle using the set of keypoints and the depth values; and at least partially controlling, by the one or more processors, operation of the vehicle according to the positions of the objects.

In another example, a device for processing image data includes: a memory configured to store image data; and one or more processors implemented in circuitry and configured to: determine a set of keypoints representing objects in an image of the image data captured by a camera of a vehicle; determine depth values for the objects in the image; determine positions of the objects relative to the vehicle using the set of keypoints and the depth values; and at least partially control operation of the vehicle according to the positions of the objects.

In another example, a device for processing image data includes: means for determining a set of keypoints representing objects in an image captured by a camera of a vehicle; means for determining depth values for the objects in the image; means for determining positions of the objects relative to the vehicle using the set of keypoints and the depth values; and means for at least partially controlling operation of the vehicle according to the positions of the objects.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example vehicle including an autonomous driving controller according to techniques of this disclosure.

FIG. 2 is a block diagram illustrating an example set of components of an autonomous driving controller according to techniques of this disclosure.

FIG. 3 is a conceptual diagram illustrating an example keypoint determination network.

FIG. 4 is a conceptual diagram illustrating an example set of keypoints for an object in an image.

FIG. 5 is a block diagram illustrating an example set of components of a depth determination unit.

FIG. 6 is a block diagram illustrating an example set of components for using depth and keypoints to detect positions of objects in images according to techniques of this disclosure.

FIG. 7 is a conceptual diagram illustrating example images captured at different times to demonstrate motion parallax.

FIG. 8 is a flowchart illustrating an example method of using keypoints and depth determined from an image to determine positions of objects represented in the image according to techniques of this disclosure.

### DETAILED DESCRIPTION

Depth estimation is an important component of autonomous driving (AD), autonomous driving assistance systems (ADAS), or other systems used to partially or fully autonomously control a vehicle. Depth estimation for such techniques may be used for autonomous driving, assistive robotics, augmented reality/virtual reality scene composition, image editing, or other such techniques.

Images captured by a camera of a vehicle may be used for various purposes, such as localization (determining where a photo was captured), object recognition, image registration (for aligning multiple images of the same scene), pose estimation (for determining an orientation of a device including a camera when an image was captured), image retrieval, image segmentation (e.g., by clustering keypoints into similar groups), panoramic image generation, image stitching, or the like. This disclosure describes techniques that may address certain problems recognized with conventional usages of keypoints.

With respect to localization, that is, determining a location of a device (e.g., a vehicle) including a camera based on an image captured by the camera, keypoints in such an image may correspond to dynamic obstacles and unwanted objects. Dynamic objects, such as vehicles, pose unique challenges. Pseudo-stationary objects (e.g., clouds lining the sky) in the environment also pose difficult challenges. These may need to be removed, since map data does not have dynamic or pseudo-stationary objects.

Additionally or alternatively, the techniques of this disclosure may address problems related to crowdsourced mapping data. For example, in such data, especially with non-semantic keypoints (that is, keypoints having descriptors), large volumes of keypoints may be generated. Thus, high bandwidth data may be sent to a backend server that generates maps. It is a challenge to keep track of potentially changed descriptors in near-real-time for three-dimensional (3D) map points, due to changing environments. For example, different vehicles may drive in the same direction on the highway, and see a largely overlapping set of keypoints along with their descriptors in each camera frame. Thus, mapping data may only be useful for a vehicle using a similar specification cameras and driving in the same lane, in which case metadata may be needed to accompany the data being used for map generation to the backend, to aid repeatability.

Thus, the techniques of this disclosure may be used to provide alternative high dimensional descriptors, to provide additional information to cross-check the quality of descriptors, and/or to improve the descriptor quality at minimal cost of additional descriptors.

According to the techniques of this disclosure, keypoint detection in combination with depth estimation may be performed using machine learning on monocular video data including a series of images. For example, depth may be estimated using structure from motion (SFM) techniques, which generally include estimating the three-dimensional (3D) structure of a scene from a set of two-dimensional images. Monocular video data refers to video data captured by a single camera. Depth estimation using video data captured by a single camera, as opposed to multiple (two or more) cameras, allows for a reduction in cost by only requiring the single camera, as well as an improvement in simplicity, since no coordination or synchronization between multiple cameras is needed. That is, stereo or multi-view camera systems must be calibrated if performing depth estimation using video data captured by such multiple camera systems, which is cumbersome and prone to errors. By contrast, monocular sequences are relatively easy to capture and sanitize.

The depth estimation techniques of this disclosure may be self-supervised. That is, a depth estimation AI/ML unit, such as a neural network, may be trained on monocular video data in order to detect depths of objects in future monocular video data. Additional sensors, such as LiDAR, are not needed for such training, because LiDAR and other range-finding sensors may be sparse and noisy. Acquiring real-world dense ground-truth depth at scale is also difficult. Instead, the techniques of this disclosure may leverage SFM principles to perform view synthesis as the self-supervision level. Thus, these techniques eliminate the need for ground-truth depth. An abundance of monocular data allows for training such AI/ML units and models.

According to the techniques of this disclosure, an autonomous driving or ADAS unit may be configured to use both depth information and keypoint information when performing autonomous driving or ADAS tasks. That is, both depth information and keypoint information may be used to detect objects ahead of, behind, and/or to the sides of a vehicle or other agent (sometimes referred to as an “ego” or “ego vehicle”). The keypoint information may be used when determining depths of the objects, and/or depth information may be used to better determine keypoints for objects and/or descriptors for the keypoints.

Combination of both depth and keypoints when analyzing images may improve object detection and position accuracy and precision, which may improve decisions made by the autonomous driving or ADAS unit. For example, the combination of depth and keypoints may be used to improve localization of a vehicle by, e.g., removing consideration of dynamic or pseudo-stationary objects from consideration when determining landmark objects in an image that may be used to determine a location of the vehicle. Similarly (additionally or alternatively), the combination of depth and keypoints may be used to improve crowdsourced mapping data, e.g., to determine more accurate descriptors for the keypoints (such that the keypoints can be recognized from various lanes of roads, for example), to reduce the amount of data sent to an aggregating server that forms maps (e.g., removing dynamic or pseudo-stationary objects), or the like. Moreover, an autonomous driving or ADAS unit may determine a position of a vehicle in the map, positions of dynamic objects (e.g., other vehicles), and use such determinations for navigation, collision avoidance, or the like.

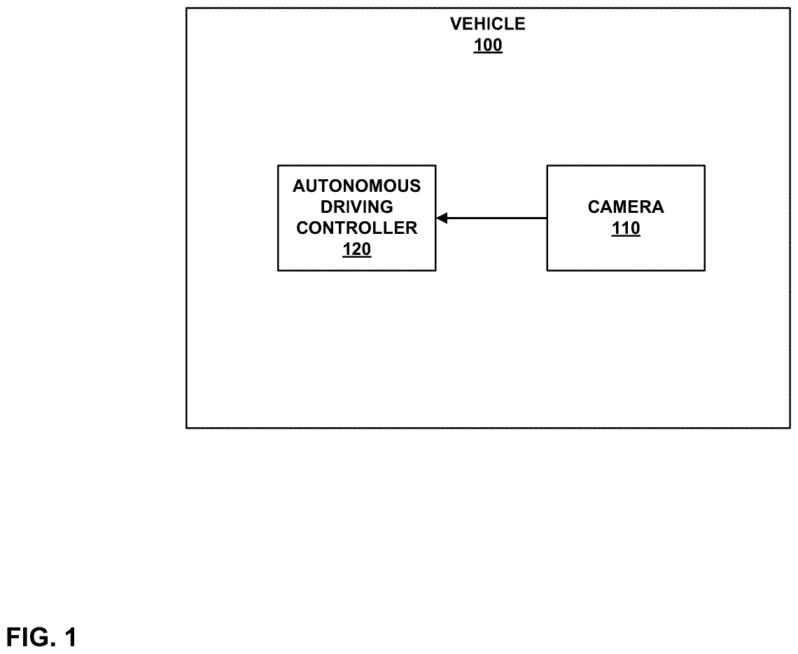

FIG. 1 is a block diagram illustrating an example vehicle 100 including an autonomous driving controller 120 according to techniques of this disclosure. In this example, vehicle 100 includes camera 110, and autonomous driving controller 120. Camera 110 is a single camera in this example. While only a single camera is shown in the example of FIG. 1, in other examples, multiple cameras may be used. However, the techniques of this disclosure allow for depth to be calculated for objects in images captured by camera 110 without additional cameras. In some examples, multiple cameras may be employed that face different directions, e.g., front, back, and to each side of vehicle 100. Autonomous driving controller 120 may be configured to calculate depth for objects captured by each of such cameras.

According to the techniques of this disclosure, autonomous driving controller 120 receives frames captured by camera 110 at a high frame rate, such as 30 fps, 60 fps, 90 fps, 120 fps, or even higher. Per the techniques of this disclosure, autonomous driving controller 120 may process the frames to determine depths of objects within the frames. Additionally, autonomous driving controller 120 may detect keypoints within the frames, as well as descriptors for the keypoints. The descriptors may represent scale and orientation of the keypoints.

According to the techniques of this disclosure, autonomous driving controller 120 may be configured to apply the depth values determined from the frames when determining the keypoints and/or descriptors for the keypoints. Additionally or alternatively, autonomous driving controller 120 may be configured to use keypoints and/or their descriptors when determining depths for objects in the frames. Ultimately, autonomous driving controller 120 may use both depth information and keypoints (and their descriptors) when determining positions of objects in the real world. Autonomous driving controller 120 may use the positions of the objects represented in the image frames when determining how best to control vehicle 100, e.g., whether to maintain or adjust speed (e.g., to brake or accelerate), and/or whether to turn left or right or to maintain current heading of vehicle 100.

Additionally or alternatively, these techniques may be employed in advanced driving assistance systems (ADAS). Rather than autonomously controlling vehicle 100, such ADASs may provide feedback to a human operator of vehicle 100, such as a warning to brake or turn if an object is too close. Additionally or alternatively, the techniques of this disclosure may be used to partially control vehicle 100, e.g., to maintain speed of vehicle 100 when no objects within a threshold distance are detected ahead of vehicle 100, or if a separate vehicle is detected ahead of vehicle 100, to match the speed of the separate vehicle if the separate vehicle is within the threshold distance, to prevent reducing the distance between vehicle 100 and the separate vehicle.

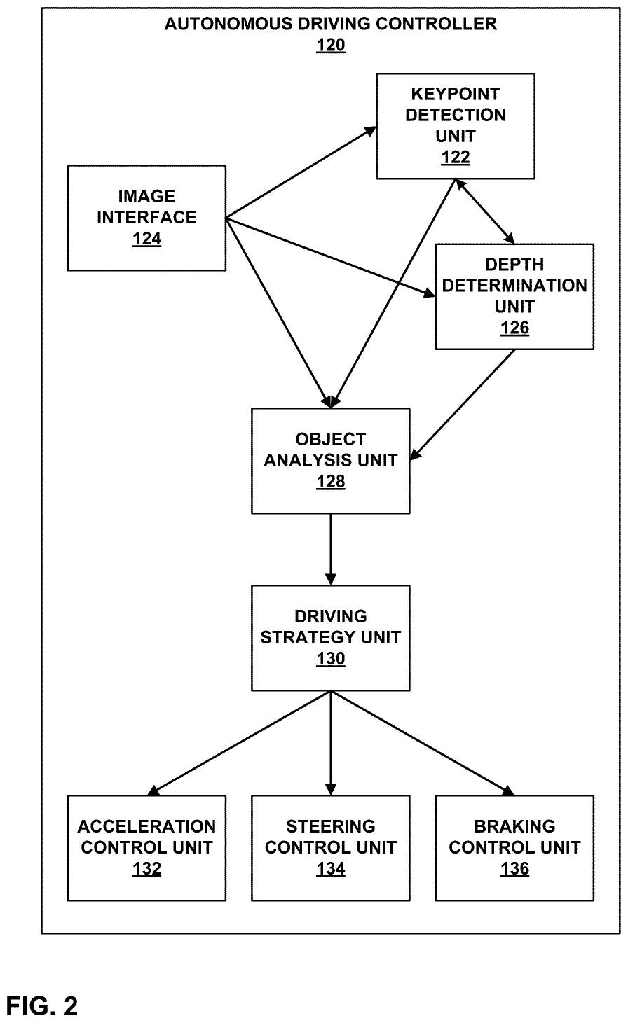

FIG. 2 is a block diagram illustrating an example set of components of autonomous driving controller 120 of FIG. 1 according to techniques of this disclosure. In this example, autonomous driving controller 120 includes keypoint detection unit 122, image interface 124, depth determination unit 126, object analysis unit 128, driving strategy unit 130, acceleration control unit 132, steering control unit 134, and braking control unit 136.

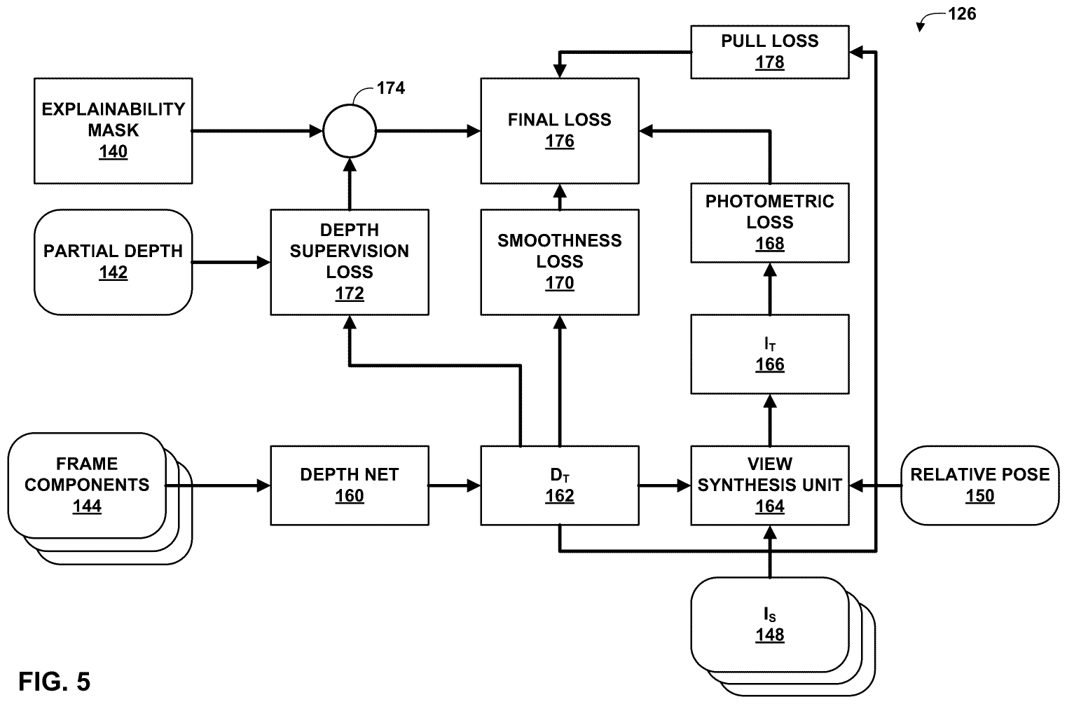

Depth determination unit 126, as explained in greater detail below with respect to FIG. 5, may determine depth of objects represented in images received via image interface 124 using the images themselves and keypoint data received from keypoint detection unit 122. For example, depth determination unit 126 may receive a pair of sequential images from camera 110 via image interface 124, as well as keypoint data. Depth determination unit 126 may apply the keypoint data when determining the depth of objects in the images. In some examples, depth determination unit 126 may use the keypoint values to confirm depth values. Additionally or alternatively, depth determination unit 126 may provide depth values to keypoint detection unit 122, which may use the depth values to confirm keypoint determinations.

Keypoint detection unit 122 receives images from camera 110 of FIG. 1 via image interface 124. Keypoint detection unit 122 may perform various techniques to extract keypoints from the images.

Image interface 124 may also provide the image frames to object analysis unit 128. Likewise, depth determination unit 126 may provide depth values for objects in the images to object analysis unit 128. Object analysis unit 128 may generally determine where objects are relative to the position of vehicle 100 at a given time, and may also determine whether the objects are stationary or moving. Object analysis unit 128 may provide object data to driving strategy unit 130, which may determine a driving strategy based on the object data. For example, driving strategy unit 130 may determine whether to accelerate, brake, and/or turn vehicle 100. Driving strategy unit 130 may execute the determined strategy by delivering vehicle control signals to various driving systems (acceleration, braking, and/or steering) via acceleration control unit 132, steering control unit 134, and braking control unit 136.

The various components of autonomous driving controller 120 may be implemented as any of a variety of suitable circuitry components, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure.

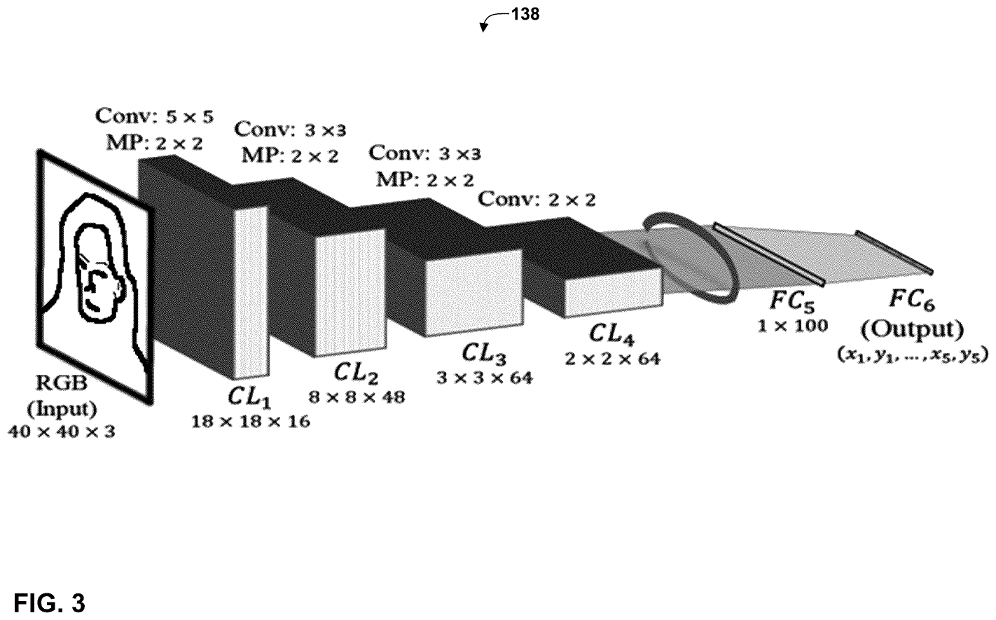

FIG. 3 is a conceptual diagram illustrating an example keypoint determination network 138. In this example, keypoint determination network 138 includes a series of various convolutional neural networks (CNNs) for extracting keypoints of an input image. In particular, the input image includes three components (e.g., RGB or YUV/YCbCr). The series of CNNs of keypoint determination network 138 includes a 5×5 CNN, a 3×3 CNN, another 3×3 CNN, a 2×2 CNN, and then two fully connected (FC) layers.

Keypoint detection can be done using various computer vision approaches, such as SIFT, KAZE, AKAZE, ORB, SURF, BRISK, or the like. In general, such approaches try to preserve invariance to affine transforms (e.g., scale, rotation, and translation). Generally, object recognition using keypoints may be performed in three steps: keypoint detection, descriptor generation, and matching. Usually, regions of varying size may be used to generate features. Deep learning approaches that employ keypoint extraction and descriptor generation include SuperPoint, UnSuperPoint, and others.

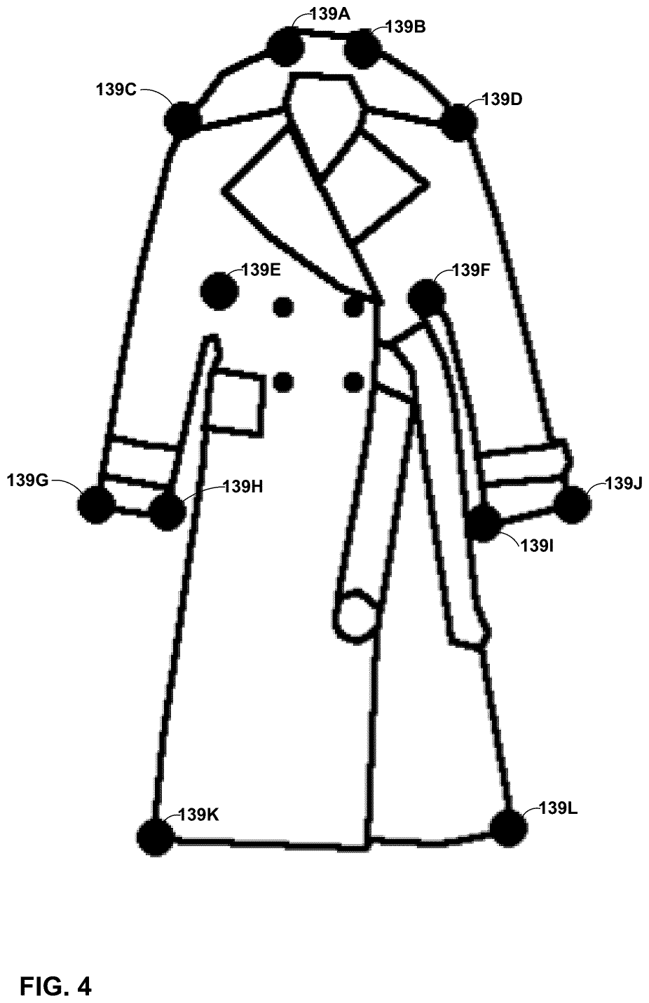

FIG. 4 is a conceptual diagram illustrating an example set of keypoints 139A-139L for an object in an image. In particular, in this example, the image depicts a coat, and the coat is represented by keypoints including:
Keypoint 139A: left neckline
Keypoint 139B: right neckline
Keypoint 139C: left shoulder
Keypoint 139D: right shoulder
Keypoint 139E: left armpit
Keypoint 139F: right armpit
Keypoint 139G: left outer cuff
Keypoint 139H: left inner cuff
Keypoint 139I: right inner cuff
Keypoint 139J: right outer cuff
Keypoint 139K: left top hem
Keypoint 139L: right top hem

By determining that this set of keypoints exist, as well as descriptors for keypoints 139, an image recognition unit can recognize that the example image of FIG. 4 includes a coat.

FIG. 5 is a block diagram illustrating an example set of components of depth determination unit 126 of FIG. 2. Depth determination unit 126 includes depth net 160, DT 162, view synthesis unit 164, IT 166, photometric loss 168, smoothness loss 170, depth supervision loss 172, combination unit 174, final loss 176, and pull loss 178. As shown in the example of FIG. 5, depth determination unit 126 receives explainability mask 140, partial depth 142, frame components 144, Is 148, and relative pose data 150.

Frame components 144 correspond to components (e.g., R, G, and B components or Y, U, and V/Y, Cb, and Cr components) of image frames, e.g., received from camera 110 of FIG. 1.

DT 162 represents a depth map at time T (corresponding to the time at which the later image was captured) as calculated by depth net 160.

View synthesis unit 164 may synthesize one or more additional views using original image frames (Is 148) and the depth map, i.e., DT 162, as well as relative pose data 150. That is, using the depth map and relative pose data 150, view synthesis unit 164 may warp samples of the original image frames to produce one or more warped image frames, such that the samples of the original image frames are moved horizontally according to the determined depth values for the object to which the samples correspond. Relative pose data 150 may be measured or estimated by a pose network. IT 166 represents the resulting warped image generated by view synthesis unit 164.

Photometric loss unit 168 may calculate photometric loss, representing photometric differences between pixels warped from the received image frames and the pixels in the warped image, i.e., IT 166. Photometric loss unit 168 may provide the photometric loss to final loss unit 176.

Smoothness loss unit 170 may calculate smoothness loss of the depth map, i.e., DT 162. Smoothness loss generally represents a degree to which depth values are smooth, e.g., represent geometrically natural depth. Smoothness loss unit 170 may provide the smoothness loss to final loss unit 176.

Depth supervision loss unit 172 may calculate depth supervision loss of the depth map, i.e., DT 162, using partial depth data 142.

Explainability mask 140 generally represents confidence values, i.e., values indicating how confident depth net 160 is for various regions/samples of calculated depth maps, such as DT 162. Thus, combination unit 174 may apply explainability mask 140 to the depth supervision loss calculated by depth supervision loss unit 172 and provide this masked input to final loss unit 176.

Pull loss unit 178 may calculate pull loss, representing a degree to which corners of an object are accurately joined in the depth map, i.e., DT 162. Pull loss unit 178 may receive data representing input shapes to calculate the pull loss. Pull loss unit 178 may provide the pull loss to final loss unit 176. The pull loss may act as a prior value for depth values to get the depth values to a predetermined set, which may help with areas for which data may not be readily understandable, such as open sky.

Ultimately, final loss unit 176 may calculate final loss, representing overall accuracy of the depth map, DT 162. The final loss may be minimized during an optimization process when training depth net 160. An optimizer for minimizing the final loss may be, for example, stochastic gradient descent, ADAM, NADAM, AdaGrad, or the like. During backpropagation of optimization, gradient values may flow backward through the final loss to other parts of the network.

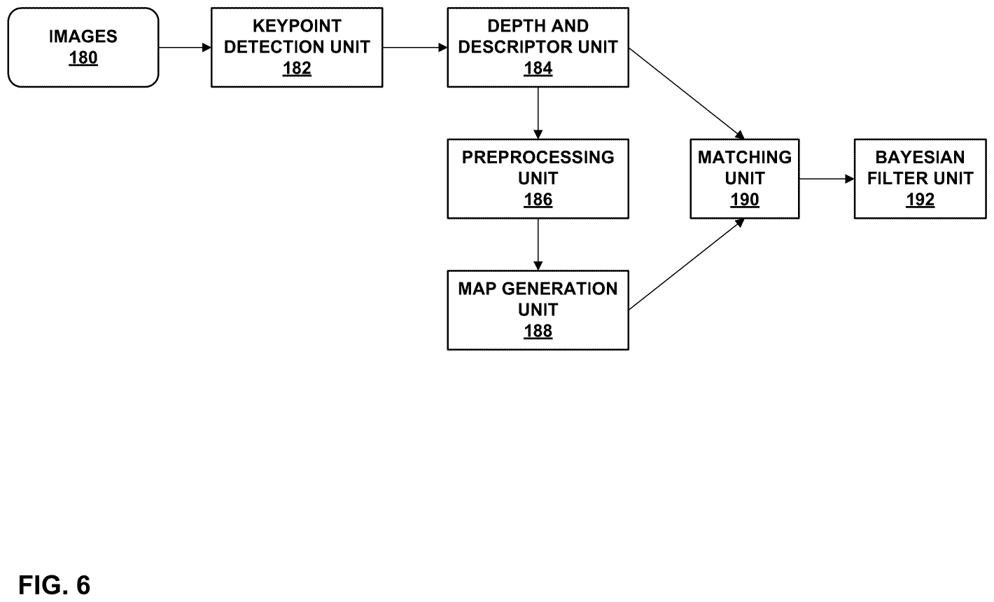

FIG. 6 is a block diagram illustrating an example set of components for using depth and keypoints to detect positions of objects in images according to techniques of this disclosure. In this example, the set of components includes keypoint detection unit 182, depth and descriptor unit 184, preprocessing unit 186, map generation unit 188, matching unit 190, and Bayesian filtering unit 192.

Keypoint detection unit 182 processes images 180 to extract and process keypoints. Keypoint detection unit 182 may provide the keypoints to depth and descriptor unit 184. Depth and descriptor unit 184 may determine depths of objects in images 180. For example, depth and descriptor unit 184 may include the component shown in FIG. 5. In addition, depth and descriptor unit 184 may use the depths of the objects (or samples, e.g., pixels, of the images) to generate descriptors for the keypoints.

For example, depth and descriptor unit 184 may use a depth value corresponding to a keypoint (e.g., collocated with the keypoint) as at least part of a descriptor for the keypoint. In some examples, depth and descriptor unit 184 may use the depth values to generate a three-dimensional (3D) point coordinate representation of objects in the images, along with the keypoints. For example, depth and descriptor unit 184 may use a pose of the vehicle (ego) and/or camera intrinsic parameters when generating the 3D point coordinate representation to achieve better-quality descriptors for the keypoints. In some examples, the depth values for the keypoints may be used as the descriptors for the keypoints. In some examples, depth and descriptor unit 184 may add the depth values as additional values to each keypoint descriptor. For example, depth can be directly added to the descriptor for a keypoint. Depth and descriptor unit 184 may use dimensionality reduction techniques to reduce an amount of data added to the descriptor. For example, if the descriptor initially has 48 dimensions, and three coordinates (corresponding to the 3D coordinates of the keypoints, as determined using the depth values) are added, the descriptor is then represented by 51 dimensions. Depth and descriptor unit 184 may use a dimensionality reduction technique to compress the resulting 51 dimensions back down to 48 dimensions. Dimensionality reduction techniques include, for example, feature selection, feature extraction, principal component analysis (PCA), non-negative matrix factorization (NMF), linear discriminant analysis (LDA), generalized discriminant analysis (GDA), missing values ratio, low variance filter, high correlation filter, backward feature elimination, forward feature construction, and random forests.

In some examples, the depth information may be used to aggregate keypoints. For example, rather than purely relying on non-maximum suppression in a neighborhood, depth and descriptor unit 184 may us depth to aggregate keypoints directly in a 3D representation and remove spatial outliers through batch processing.

In some examples, depth and descriptor unit 184 may use the depth values to lift a scene to 3D. Thus, descriptors might not even be needed. This can be done by matching they keypoint in the 3D world using position data. This may be particularly helpful when points with notably different depth values have a projection on a camera image very close to each other. That is, the close proximity in the image may seem to indicate that the corresponding real world objects are close, but the depth values may reveal that in fact, the objects are further apart along the dimension of depth.

In some examples, depth and descriptor unit 184 may use the depth values to evaluate the quality of determined descriptors. For example, depth and descriptor unit 184 may perform keypoint matching to generate the descriptors. After performing the keypoint matching, depth and descriptor unit 184 may use the depth values as a supervisory signal to check if the matchings are valid. This allows depth and descriptor unit 184 to numerically associate an objective function to the descriptor generation technique. This may be performed in conjunction with other losses, or objective functions, or used by itself. This may numerically optimize the keypoint selection and descriptor generation techniques.

When tracking points, e.g., across frames over time, various filters may be used, such as a Kalman filter, an extended Kalman filter, an unscented Kalman filter, a Bayesian filter, a particle filter, or the like. When tracking points in this manner, depth values may be used to initialize states corresponding to geometry of objects, e.g., for various objects and planar surfaces, such as traffic signs, lights, and other roadside objects.

Preprocessing unit 186 may pre-process the keypoints and descriptors, and potentially depth values, to, e.g., reduce bandwidth and remove outlier keypoints. Preprocessing unit 186 may remove false points from a 2D cluster seen in one of images 180 using the depth values. Preprocessing unit 186 may, additionally or alternatively, compress the descriptors, quantize keypoints to reduce bandwidth, and/or append pose information for the vehicle to the keypoints.

Map generation unit 188 may provide the keypoints to a server that collects keypoints and location information from many participants and associates the keypoints and depth information with location information. In this manner, subsequently, the keypoints may be used to determine a location of one or more other vehicles in the future. For example, the size of the object in an image may, along with depth values for the object, may generally indicate how close or far a vehicle is from the object. By determining distances from several unmoving objects, such as landmarks, the position of the vehicle can be determined.

Matching unit 190 may match keypoints to such landmark objects, and Bayesian filter unit 192 may update a model associating keypoints and locations.

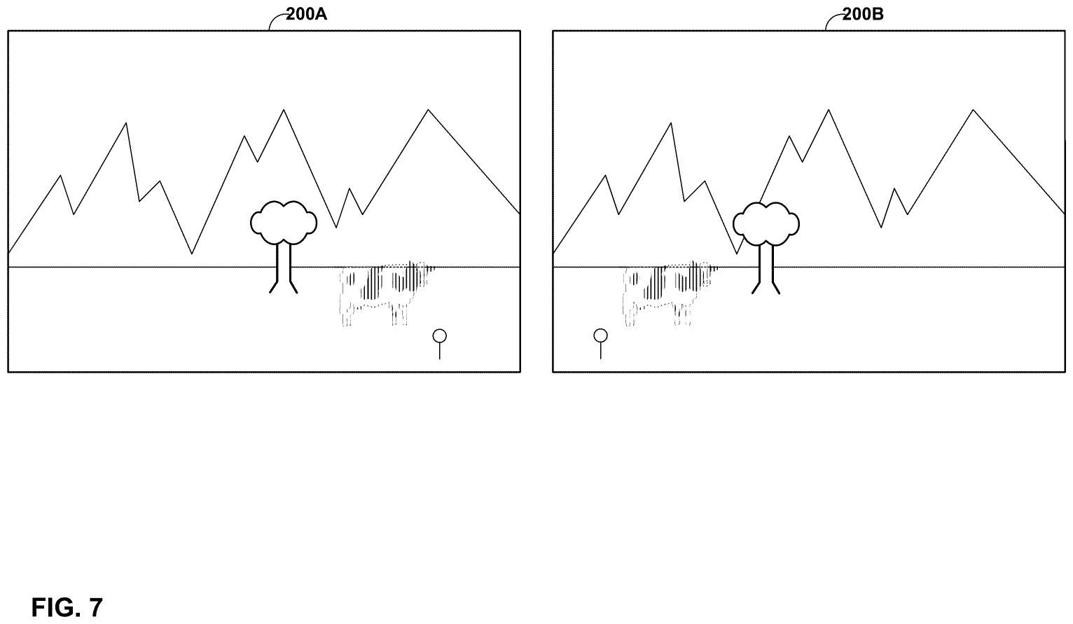

FIG. 7 is a conceptual diagram illustrating example images 200A, 200B captured at different times to demonstrate motion parallax. Motion parallax is generally the concept that objects moving at a constant speed across a frame of image data will appear to move a greater amount if they are closer to the camera than objects at further distances.

In the example of FIG. 7, it is assumed that image 200A is captured by a camera at a first time, and that image 200B is captured by the camera at a second, later time. The camera is assumed to be mounted in a vehicle that is traveling parallel with the mountains in the distance of images 200A, 200B. Thus, as can be seen in the example of FIG. 7, objects closer to the camera, such as the flower and cow, appear to move more than objects further from the camera, such as the tree, and the mountains in the far distance appear not to move at all between images 200A and 200B.

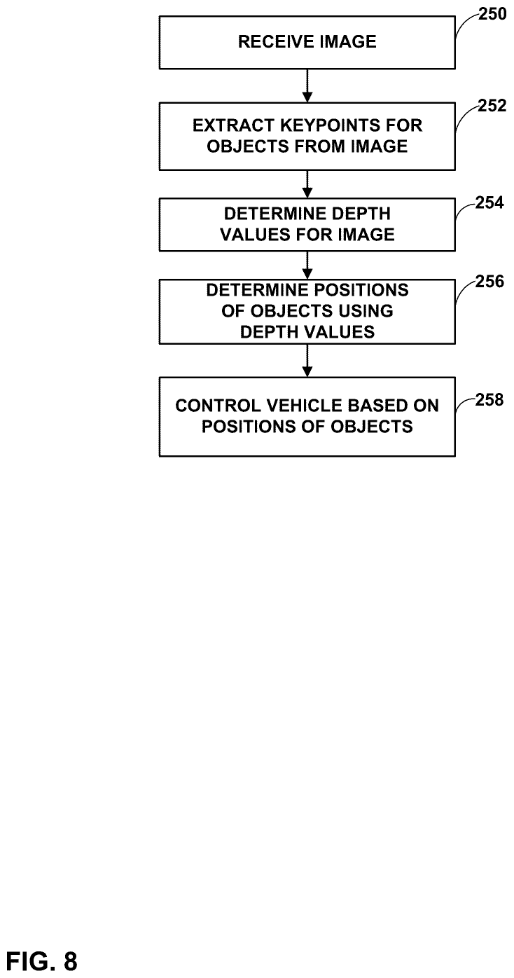

FIG. 8 is a flowchart illustrating an example method of using keypoints and depth determined from an image to determine positions of objects represented in the image according to techniques of this disclosure. The method of FIG. 8 is described with respect to autonomous driving controller 120 of FIGS. 1 and 2 for purposes of explanation.

Initially, autonomous driving controller 120 receives an image (250), e.g., from camera 110 of vehicle 100. Autonomous driving controller 120 may then extract keypoints for objects represented in the image (252). Autonomous driving controller 120 may also determine depth values for the image (254). Autonomous driving controller 120 may further determine positions of the objects represented in the image using the depth values (256). For example, the depth values may be used as descriptors for the keypoints, the depth values may supplement other descriptor values for the keypoints, the depth values may be used to aggregate the keypoints, the depth values may be used to represent the positions of the keypoints in a 3D space (e.g., the real world), the depth values may be used to determine the quality of descriptors for the keypoints, or the like. Ultimately, autonomous driving controller 120 may control the operation of vehicle 100 in some manner based on the positions of the objects (258), e.g., to perform navigation toward a target location based on a current position of vehicle 100 as determined according to the relative position of vehicle 100 relative to the positions of the objects.

In this manner, the method of FIG. 8 represents an example of a method of processing image data including determining, by one or more processors implemented in circuitry, a set of keypoints representing objects in an image captured by a camera of a vehicle; determining, by the one or more processors, depth values for the objects in the image; determining, by the one or more processors, positions of the objects relative to the vehicle using the set of keypoints and the depth values; and at least partially controlling, by the one or more processors, operation of the vehicle according to the positions of the objects.

Various examples of the techniques of this disclosure are summarized in the following clauses:

Clause 1: A method of processing image data, the method comprising:
determining, by one or more processors implemented in circuitry, a set of keypoints representing objects in an image captured by a camera of a vehicle; determining, by the one or more processors, depth values for the objects in the image; determining, by the one or more processors, positions of the objects relative to the vehicle using the set of keypoints and the depth values; and at least partially controlling, by the one or more processors, operation of the vehicle according to the positions of the objects.

Clause 2: The method of clause 1, further comprising using the depth values as descriptors for the keypoints.

Clause 3: The method of clause 1, further comprising determining a pose of the vehicle, wherein determining the positions of the objects comprises determining a three-dimensional point coordinate representation of the objects according to the depth values, the keypoints, and the pose of the vehicle.

Clause 4: The method of clause 1, further comprising adding the depth values to descriptors for the keypoints.

Clause 5: The method of clause 1, further comprising forming a set of aggregate keypoints from the set of keypoints according to the depth values, wherein determining the positions of the objects comprises determining the positions of the objects according to the set of aggregate keypoints.

Clause 6: The method of clause 1, wherein determining the positions of the objects comprises applying the depth values to the keypoints to determine a three-dimensional point coordinate representation of the positions of the objects.

Clause 7: The method of clause 1, further comprising: determining descriptors for the keypoints; and evaluating quality of the descriptors using the depth values, wherein determining the positions of the objects comprises evaluating validity of matchings of the objects using the quality of the descriptors.

Clause 8: The method of clause 1, further comprising determining sets of keypoints for a series of images captured by the camera of the vehicle and tracking movement of the keypoints between the images using a filter, including initializing one or more geometry states for the objects using the depth values.

Clause 9: The method of clause 1, wherein at least partially controlling the operation of the vehicle comprises: determining a location of the vehicle according to the positions of the objects; and determining a navigation route for the vehicle to a destination according to the location of the vehicle.

Clause 10: A device for processing image data, the device comprising: a memory configured to store image data; and one or more processors implemented in circuitry and configured to: determine a set of keypoints representing objects in an image of the image data captured by a camera of a vehicle; determine depth values for the objects in the image; determine positions of the objects relative to the vehicle using the set of keypoints and the depth values; and at least partially control operation of the vehicle according to the positions of the objects.

Clause 11: The device of clause 10, wherein the one or more processors are further configured to use the depth values as descriptors for the keypoints.

Clause 12: The device of clause 10, wherein the one or more processors are further configured to determine a pose of the vehicle, wherein to determine the positions of the objects, the one or more processors are configured to determine a three-dimensional point coordinate representation of the objects according to the depth values, the keypoints, and the pose of the vehicle.

Clause 13: The device of clause 10, wherein the one or more processors are further configured to add the depth values to descriptors for the keypoints.

Clause 14: The device of clause 10, wherein the one or more processors are further configured to form a set of aggregate keypoints from the set of keypoints according to the depth values, wherein to determine the positions of the objects, the one or more processors are configured to determine the positions of the objects according to the set of aggregate keypoints.

Clause 15: The device of clause 10, wherein to determine the positions of the objects, the one or more processors are configured to apply the depth values to the keypoints to determine a three-dimensional point coordinate representation of the positions of the objects.

Clause 16: The device of clause 10, wherein the one or more processors are further configured to: determine descriptors for the keypoints; and evaluate quality of the descriptors using the depth values, wherein to determine the positions of the objects, the one or more processors are further configured to evaluate validity of matchings of the objects using the quality of the descriptors.

Clause 17: The device of clause 10, wherein the one or more processors are further configured to determine sets of keypoints for a series of images captured by the camera of the vehicle and to track movement of the keypoints between the images using a filter, and wherein the one or more processors are configured to initialize one or more geometry states for the objects using the depth values.

Clause 18: The device of clause 10, wherein to at least partially control the operation of the vehicle, the one or more processors are configured to: determine a location of the vehicle according to the positions of the objects; and determine a navigation route for the vehicle to a destination according to the location of the vehicle.

Clause 19: A device for processing image data, the device comprising: means for determining a set of keypoints representing objects in an image captured by a camera of a vehicle; means for determining depth values for the objects in the image; means for determining positions of the objects relative to the vehicle using the set of keypoints and the depth values; and means for at least partially controlling operation of the vehicle according to the positions of the objects.

Clause 20: The device of clause 19, further comprising means for using the depth values as descriptors for the keypoints.

Clause 21: The device of clause 19, further comprising means for determining a pose of the vehicle, wherein the means for determining the positions of the objects comprises means for determining a three-dimensional point coordinate representation of the objects according to the depth values, the keypoints, and the pose of the vehicle.

Clause 22: The device of clause 19, further comprising means for adding the depth values to descriptors for the keypoints.

Clause 23: The device of clause 19, further comprising means for forming a set of aggregate keypoints from the set of keypoints according to the depth values, wherein the means for determining the positions of the objects comprises means for determining the positions of the objects according to the set of aggregate keypoints.

Clause 24: The device of clause 19, wherein the means for determining the positions of the objects comprises means for applying the depth values to the keypoints to determine a three-dimensional point coordinate representation of the positions of the objects.

Clause 25: The device of clause 19, further comprising: means for determining descriptors for the keypoints; and means for evaluating quality of the descriptors using the depth values, wherein the means for determining the positions of the objects comprises means for evaluating validity of matchings of the objects using the quality of the descriptors.

Clause 26: The device of clause 19, further comprising means for determining sets of keypoints for a series of images captured by the camera of the vehicle and means for tracking movement of the keypoints between the images using a filter, including means for initializing one or more geometry states for the objects using the depth values.

Clause 27: The device of clause 19, wherein the means for at least partially controlling the operation of the vehicle comprises: means for determining a location of the vehicle according to the positions of the objects; and means for determining a navigation route for the vehicle to a destination according to the location of the vehicle.

Clause 28: A computer-readable storage medium having stored thereon instructions that, when executed, cause a processor to: determine a set of keypoints representing objects in an image captured by a camera of a vehicle; determine depth values for the objects in the image; determine positions of the objects relative to the vehicle using the set of keypoints and the depth values; and at least partially control operation of the vehicle according to the positions of the objects.

Clause 29: The computer-readable storage medium of clause 28, further comprising instructions that cause the processor to use the depth values as descriptors for the keypoints.

Clause 30: The computer-readable storage medium of clause 28, further comprising instructions that cause the processor to determine a pose of the vehicle, wherein the instructions that cause the processor to determine the positions of the objects comprise instructions that cause the processor to determine a three-dimensional point coordinate representation of the objects according to the depth values, the keypoints, and the pose of the vehicle.

Clause 31: The computer-readable storage medium of clause 28, further comprising instructions that cause the processor to add the depth values to descriptors for the keypoints.

Clause 32: The computer-readable storage medium of clause 28, further comprising instructions that cause the processor to form a set of aggregate keypoints from the set of keypoints according to the depth values, wherein the instructions that cause the processor to determine the positions of the objects comprise instructions that cause the processor to determine the positions of the objects according to the set of aggregate keypoints.

Clause 33: The computer-readable storage medium of clause 28, wherein the instructions that cause the processor to determine the positions of the objects comprise instructions that cause the processor to apply the depth values to the keypoints to determine a three-dimensional point coordinate representation of the positions of the objects.

Clause 34: The computer-readable storage medium of clause 28, further comprising instructions that cause the processor to: determine descriptors for the keypoints; and evaluate quality of the descriptors using the depth values, wherein the instructions that cause the processor to determine the positions of the objects comprise instructions that cause the processor to evaluate validity of matchings of the objects using the quality of the descriptors.

Clause 35: The computer-readable storage medium of clause 28, further comprising instructions that cause the processor to determine sets of keypoints for a series of images captured by the camera of the vehicle and tracking movement of the keypoints between the images using a filter, including instructions that cause the processor to initialize one or more geometry states for the objects using the depth values.

Clause 36: The computer-readable storage medium of clause 28, wherein the instructions that cause the processor to at least partially controlling the operation of the vehicle comprise instructions that cause the processor to: determine a location of the vehicle according to the positions of the objects; and determine a navigation route for the vehicle to a destination according to the location of the vehicle.

Clause 37: A method of processing image data, the method comprising:
determining, by one or more processors implemented in circuitry, a set of keypoints representing objects in an image captured by a camera of a vehicle; determining, by the one or more processors, depth values for the objects in the image; determining, by the one or more processors, positions of the objects relative to the vehicle using the set of keypoints and the depth values; and at least partially controlling, by the one or more processors, operation of the vehicle according to the positions of the objects.

Clause 38: The method of clause 37, further comprising using the depth values as descriptors for the keypoints.

Clause 39: The method of any of clauses 37 and 38, further comprising determining a pose of the vehicle, wherein determining the positions of the objects comprises determining a three-dimensional point coordinate representation of the objects according to the depth values, the keypoints, and the pose of the vehicle.

Clause 40: The method of any of clauses 37-39, further comprising adding the depth values to descriptors for the keypoints.

Clause 41: The method of any of clauses 37-40, further comprising forming a set of aggregate keypoints from the set of keypoints according to the depth values, wherein determining the positions of the objects comprises determining the positions of the objects according to the set of aggregate keypoints.

Clause 42: The method of any of clauses 37-41, wherein determining the positions of the objects comprises applying the depth values to the keypoints to determine a three-dimensional point coordinate representation of the positions of the objects.

Clause 43: The method of any of clauses 37-42, further comprising: determining descriptors for the keypoints; and evaluating quality of the descriptors using the depth values, wherein determining the positions of the objects comprises evaluating validity of matchings of the objects using the quality of the descriptors.

Clause 44: The method of any of clauses 37-43, further comprising determining sets of keypoints for a series of images captured by the camera of the vehicle and tracking movement of the keypoints between the images using a filter, including initializing one or more geometry states for the objects using the depth values.

Clause 45: The method of any of clauses 37-44, wherein at least partially controlling the operation of the vehicle comprises: determining a location of the vehicle according to the positions of the objects; and determining a navigation route for the vehicle to a destination according to the location of the vehicle.

Clause 46: A device for processing image data, the device comprising: a memory configured to store image data; and one or more processors implemented in circuitry and configured to: determine a set of keypoints representing objects in an image of the image data captured by a camera of a vehicle; determine depth values for the objects in the image; determine positions of the objects relative to the vehicle using the set of keypoints and the depth values; and at least partially control operation of the vehicle according to the positions of the objects.

Clause 47: The device of clause 46, wherein the one or more processors are further configured to use the depth values as descriptors for the keypoints.

Clause 48: The device of any of clauses 46 and 47, wherein the one or more processors are further configured to determine a pose of the vehicle, wherein to determine the positions of the objects, the one or more processors are configured to determine a three-dimensional point coordinate representation of the objects according to the depth values, the keypoints, and the pose of the vehicle.

Clause 49: The device of any of clauses 46-48, wherein the one or more processors are further configured to add the depth values to descriptors for the keypoints.

Clause 50: The device of any of clauses 46-49, wherein the one or more processors are further configured to form a set of aggregate keypoints from the set of keypoints according to the depth values, wherein to determine the positions of the objects, the one or more processors are configured to determine the positions of the objects according to the set of aggregate keypoints.

Clause 51: The device of any of clauses 46-50, wherein to determine the positions of the objects, the one or more processors are configured to apply the depth values to the keypoints to determine a three-dimensional point coordinate representation of the positions of the objects.

Clause 52: The device of any of clauses 46-51, wherein the one or more processors are further configured to: determine descriptors for the keypoints; and evaluate quality of the descriptors using the depth values, wherein to determine the positions of the objects, the one or more processors are further configured to evaluate validity of matchings of the objects using the quality of the descriptors.

Clause 53: The device of any of clauses 46-52, wherein the one or more processors are further configured to determine sets of keypoints for a series of images captured by the camera of the vehicle and to track movement of the keypoints between the images using a filter, and wherein the one or more processors are configured to initialize one or more geometry states for the objects using the depth values.

Clause 54: The device of any of clauses 46-53, wherein to at least partially control the operation of the vehicle, the one or more processors are configured to: determine a location of the vehicle according to the positions of the objects; and determine a navigation route for the vehicle to a destination according to the location of the vehicle.

Clause 55: A device for processing image data, the device comprising: means for determining a set of keypoints representing objects in an image captured by a camera of a vehicle; means for determining depth values for the objects in the image; means for determining positions of the objects relative to the vehicle using the set of keypoints and the depth values; and means for at least partially controlling operation of the vehicle according to the positions of the objects.

Clause 56: The device of clause 55, further comprising means for using the depth values as descriptors for the keypoints.

Clause 57: The device of any of clauses 55 and 56, further comprising means for determining a pose of the vehicle, wherein the means for determining the positions of the objects comprises means for determining a three-dimensional point coordinate representation of the objects according to the depth values, the keypoints, and the pose of the vehicle.

Clause 58: The device of any of clauses 55-57, further comprising means for adding the depth values to descriptors for the keypoints.

Clause 59: The device of any of clauses 55-58, further comprising means for forming a set of aggregate keypoints from the set of keypoints according to the depth values, wherein the means for determining the positions of the objects comprises means for determining the positions of the objects according to the set of aggregate keypoints.

Clause 60: The device of any of clauses 55-59, wherein the means for determining the positions of the objects comprises means for applying the depth values to the keypoints to determine a three-dimensional point coordinate representation of the positions of the objects.

Clause 61: The device of any of clauses 55-60, further comprising: means for determining descriptors for the keypoints; and means for evaluating quality of the descriptors using the depth values, wherein the means for determining the positions of the objects comprises means for evaluating validity of matchings of the objects using the quality of the descriptors.

Clause 62: The device of any of clauses 55-61, further comprising means for determining sets of keypoints for a series of images captured by the camera of the vehicle and means for tracking movement of the keypoints between the images using a filter, including means for initializing one or more geometry states for the objects using the depth values.

Clause 63: The device of any of clauses 55-62, wherein the means for at least partially controlling the operation of the vehicle comprises: means for determining a location of the vehicle according to the positions of the objects; and means for determining a navigation route for the vehicle to a destination according to the location of the vehicle.

Clause 64: A computer-readable storage medium having stored thereon instructions that, when executed, cause a processor to: determine a set of keypoints representing objects in an image captured by a camera of a vehicle; determine depth values for the objects in the image; determine positions of the objects relative to the vehicle using the set of keypoints and the depth values; and at least partially control operation of the vehicle according to the positions of the objects.

Clause 65: The computer-readable storage medium of clause 64, further comprising instructions that cause the processor to use the depth values as descriptors for the keypoints.

Clause 66: The computer-readable storage medium of any of clauses 64 and 65, further comprising instructions that cause the processor to determine a pose of the vehicle, wherein the instructions that cause the processor to determine the positions of the objects comprise instructions that cause the processor to determine a three-dimensional point coordinate representation of the objects according to the depth values, the keypoints, and the pose of the vehicle.

Clause 67: The computer-readable storage medium of any of clauses 64-66, further comprising instructions that cause the processor to add the depth values to descriptors for the keypoints.

Clause 68: The computer-readable storage medium of any of clauses 64-67, further comprising instructions that cause the processor to form a set of aggregate keypoints from the set of keypoints according to the depth values, wherein the instructions that cause the processor to determine the positions of the objects comprise instructions that cause the processor to determine the positions of the objects according to the set of aggregate keypoints.

Clause 69: The computer-readable storage medium of any of clauses 64-68, wherein the instructions that cause the processor to determine the positions of the objects comprise instructions that cause the processor to apply the depth values to the keypoints to determine a three-dimensional point coordinate representation of the positions of the objects.

Clause 70: The computer-readable storage medium of any of clauses 64-69, further comprising instructions that cause the processor to: determine descriptors for the keypoints; and evaluate quality of the descriptors using the depth values, wherein the instructions that cause the processor to determine the positions of the objects comprise instructions that cause the processor to evaluate validity of matchings of the objects using the quality of the descriptors.

Clause 71: The computer-readable storage medium of any of clauses 64-70, further comprising instructions that cause the processor to determine sets of keypoints for a series of images captured by the camera of the vehicle and tracking movement of the keypoints between the images using a filter, including instructions that cause the processor to initialize one or more geometry states for the objects using the depth values.

Clause 72: The computer-readable storage medium of any of clauses 64-71, wherein the instructions that cause the processor to at least partially controlling the operation of the vehicle comprise instructions that cause the processor to: determine a location of the vehicle according to the positions of the objects; and determine a navigation route for the vehicle to a destination according to the location of the vehicle.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method of processing image data, the method comprising:
determining, by one or more processors implemented in circuitry, a set of keypoints representing objects in an image captured by a camera of a vehicle;
determining, by the one or more processors, depth values for the objects in the image;
determining, by the one or more processors, positions of the objects relative to the vehicle using the set of keypoints and the depth values; and
at least partially controlling, by the one or more processors, operation of the vehicle according to the positions of the objects.

2. The method of claim 1, further comprising using the depth values as descriptors for the keypoints.

3. The method of claim 1, further comprising determining a pose of the vehicle, wherein determining the positions of the objects comprises determining a three-dimensional point coordinate representation of the objects according to the depth values, the keypoints, and the pose of the vehicle.

4. The method of claim 1, further comprising adding the depth values to descriptors for the keypoints.

5. The method of claim 1, further comprising forming a set of aggregate keypoints from the set of keypoints according to the depth values, wherein determining the positions of the objects comprises determining the positions of the objects according to the set of aggregate keypoints.

6. The method of claim 1, wherein determining the positions of the objects comprises applying the depth values to the keypoints to determine a three-dimensional point coordinate representation of the positions of the objects.

7. The method of claim 1, further comprising:
determining descriptors for the keypoints; and
evaluating quality of the descriptors using the depth values,
wherein determining the positions of the objects comprises evaluating validity of matchings of the objects using the quality of the descriptors.

8. The method of claim 1, further comprising determining sets of keypoints for a series of images captured by the camera of the vehicle and tracking movement of the keypoints between the images using a filter, including initializing one or more geometry states for the objects using the depth values.

9. The method of claim 1, wherein at least partially controlling the operation of the vehicle comprises:
determining a location of the vehicle according to the positions of the objects; and
determining a navigation route for the vehicle to a destination according to the location of the vehicle.

10. A device for processing image data, the device comprising:
a memory configured to store image data; and
one or more processors implemented in circuitry and configured to:
determine a set of keypoints representing objects in an image of the image data captured by a camera of a vehicle;
determine depth values for the objects in the image;
determine positions of the objects relative to the vehicle using the set of keypoints and the depth values; and
at least partially control operation of the vehicle according to the positions of the objects.

11. The device of claim 10, wherein the one or more processors are further configured to use the depth values as descriptors for the keypoints.

12. The device of claim 10, wherein the one or more processors are further configured to determine a pose of the vehicle, wherein to determine the positions of the objects, the one or more processors are configured to determine a three-dimensional point coordinate representation of the objects according to the depth values, the keypoints, and the pose of the vehicle.

13. The device of claim 10, wherein the one or more processors are further configured to add the depth values to descriptors for the keypoints.

14. The device of claim 10, wherein the one or more processors are further configured to form a set of aggregate keypoints from the set of keypoints according to the depth values, wherein to determine the positions of the objects, the one or more processors are configured to determine the positions of the objects according to the set of aggregate keypoints.

15. The device of claim 10, wherein to determine the positions of the objects, the one or more processors are configured to apply the depth values to the keypoints to determine a three-dimensional point coordinate representation of the positions of the objects.

16. The device of claim 10, wherein the one or more processors are further configured to:
determine descriptors for the keypoints; and
evaluate quality of the descriptors using the depth values,
wherein to determine the positions of the objects, the one or more processors are further configured to evaluate validity of matchings of the objects using the quality of the descriptors.

17. The device of claim 10, wherein the one or more processors are further configured to determine sets of keypoints for a series of images captured by the camera of the vehicle and to track movement of the keypoints between the images using a filter, and wherein the one or more processors are configured to initialize one or more geometry states for the objects using the depth values.

18. The device of claim 10, wherein to at least partially control the operation of the vehicle, the one or more processors are configured to:
determine a location of the vehicle according to the positions of the objects; and
determine a navigation route for the vehicle to a destination according to the location of the vehicle.

19. A device for processing image data, the device comprising:
means for determining a set of keypoints representing objects in an image captured by a camera of a vehicle;
means for determining depth values for the objects in the image;
means for determining positions of the objects relative to the vehicle using the set of keypoints and the depth values; and
means for at least partially controlling operation of the vehicle according to the positions of the objects.

20. The device of claim 19, further comprising means for using the depth values as descriptors for the keypoints.

21. The device of claim 19, further comprising means for determining a pose of the vehicle, wherein the means for determining the positions of the objects comprises means for determining a three-dimensional point coordinate representation of the objects according to the depth values, the keypoints, and the pose of the vehicle.

22. The device of claim 19, further comprising means for adding the depth values to descriptors for the keypoints.

23. The device of claim 19, further comprising means for forming a set of aggregate keypoints from the set of keypoints according to the depth values, wherein the means for determining the positions of the objects comprises means for determining the positions of the objects according to the set of aggregate keypoints.

24. The device of claim 19, wherein the means for determining the positions of the objects comprises means for applying the depth values to the keypoints to determine a three-dimensional point coordinate representation of the positions of the objects.

25. The device of claim 19, further comprising:
means for determining descriptors for the keypoints; and
means for evaluating quality of the descriptors using the depth values,
wherein the means for determining the positions of the objects comprises means for evaluating validity of matchings of the objects using the quality of the descriptors.

26. The device of claim 19, further comprising means for determining sets of keypoints for a series of images captured by the camera of the vehicle and means for tracking movement of the keypoints between the images using a filter, including means for initializing one or more geometry states for the objects using the depth values.

27. The device of claim 19, wherein the means for at least partially controlling the operation of the vehicle comprises:
means for determining a location of the vehicle according to the positions of the objects; and
means for determining a navigation route for the vehicle to a destination according to the location of the vehicle.
